(19) United States
(12) Patent Application Publication
(10) Pub. No.: US 2012/0181427 A1
(43) Pub. Date: Jul. 19, 2012

(54) RADIATION IMAGE CAPTURING APPARATUS AND RADIATION IMAGE DETECTOR

(75) Inventor: Yasuhisa KANEKO, Ashigarakami-gun (JP)

(73) Assignee: FUJIFILM CORPORATION, Tokyo (JP)

(21) Appl. No.: 13/350,177

(22) Filed: Jan. 13, 2012

(30) Foreign Application Priority Data
Jan. 14, 2011 (JP) 2011-005910
Jan. 10, 2012 (JP) 2012-002136

(51) Int. Cl. G01N 23/20

(52) U.S. Cl. 250/336.1

(57) ABSTRACT

A radiation image capturing apparatus for obtaining a phase contrast image using first and second grids in which either one of the grids is formed of a plurality of unit grids, each corresponding to each pixel circuit, and at least three unit grids in a predetermined area corresponding to one pixel of the phase contrast image are disposed shifted in parallel by different distances with respect to the other grid and arithmetic units for calculating at least two signals for generating the one pixel of the phase contrast image based on pixel signals read out from the pixel circuits corresponding to the at least three unit grids in the predetermined area, the number of the signals being smaller than the number of the pixel signals, are provided in the radiation image detector.

### BACKGROUND OF THE INVENTION

1. Field of the Invention

The present invention relates to a radiation image capturing apparatus that employs a grid and a radiation image detector used for the radiation image capturing apparatus.

2. Description of the Related Art

X-rays are used as a probe for looking through the inside of a subject as they attenuate, when passing through a substance, according to the atomic number of the element constituting the substance, as well as the density and thickness of the substance. X-ray imaging is widely used in the fields of medical diagnosis, nondestructive inspection, and the like.

In a general X-ray imaging system, a transmission image of a subject is captured by placing the subject between an X-ray source that emits X-rays and an X-ray image detector that detects X-ray images. In this case, each X-ray emitted from the X-ray source toward the X-ray image detector is incident on the X-ray detector after being attenuated (absorbed) by an amount corresponding to a difference in properties (atomic number, density, thickness) of the substance constituting the subject located in the transmission path from the X-ray source to the X-ray image detector. As a result, an X-ray transmission image of the subject is detected by the X-ray image detector and a radiation image is produced. As for the X-ray image detector, flat panel detectors (FPDs) using a semiconductor circuit are widely used, in addition to combinations of X-ray intensifying screens with films and photostimulable phosphors (storage phosphors)

However, the X-ray absorption power is low for a substance constituted by an element with a small atomic number in comparison with a substance constituted by an element with a high atomic number. As such, the difference in X-ray absorption power is small in soft biological tissues and soft materials, thereby causing a problem of insufficient contrast as an X-ray transmission image. For example, the cartilage portion and joint fluid constituting a joint of a human body are mostly made of water and the difference in the amount of X-ray absorption between them is small, thereby resulting in a low image contrast.

Recently, research has been conducted on X-ray phase imaging for obtaining a phase contrast image based on X-ray phase change resulting from the difference in refractive index of subject instead of X-ray intensity change resulting from the difference in absorption coefficient of subject. The X-ray phase imaging using the phase difference may obtain a high contrast image even for a weak absorption object having a low X-ray absorption power.

As for the X-ray phase imaging described above, an X-ray phase image capturing system in which first and second grids are disposed in parallel at a given distance to form a self-image of the first grid at the position of the second grid by the Talbot interference effect and an X-ray phase contrast image is obtained by intensity-modulating the self-image by the second grid is proposed as described, for example, in International Patent Publication No. WO2008/102654 or Japanese Unexamined Patent Publication No. 2010-190777.

In the radiation phase contrast image capturing system described in International Patent Publication No. WO2008/102654 or Japanese Unexamined Patent Publication No. 2010-190777, the second grid is disposed substantially parallel to the surface of the first grid and a fringe scanning method is performed in which the first or second grid is translated relative to the other grid in a direction substantially perpendicular to a grid direction in increments of a predetermined amount which is smaller than the grid pitch and image capturing is performed with respect to each translation movement to capture a plurality of images, and an amount of phase variation (phase shift differential amount) of X-ray caused by an interaction with a subject is obtained based on the plurality of images. Then, based on the phase shift differential amount, a phase contrast image of the subject may be obtained.

In the radiation phase contrast image capturing system described in International Patent Publication No. WO2008/102654 or Japanese Unexamined Patent Publication No. 2010-190777, however, it is necessary to accurately move the first or second grid with a pitch finer than the grid pitch, as described above. Typically, the grid pitch is several micrometers, and further high accuracy is required for the grid feeding, thereby resulting in complicated mechanisms and increased cost. Further, in the case where an image capturing operation is performed each time the grid is moved, the positional relationship between the subject and image capturing system may be changed due to a motion of the subject or a vibration of the system between each of a series of image capturing operations for obtaining a phase contrast image, thereby posing a problem that a phase variation of the X-ray caused by an interaction with the subject is not derived correctly and a favorable phase contrast image cannot be obtained.

Further, in the radiation phase image capturing system described above, a radiation image is captured each time the grid is moved using a radiation image detector in which multiple pixel circuits are disposed two-dimensionally, and a phase contrast image is generated by arithmetic processing based on a plurality of radiation images. This poses a problem that the plurality of radiation images amounts to a large volume of data and it takes a long time for the arithmetic processing.

For example, in the case where a so-called TFT (thin film transistor) readout radiation image detector having multiple pixel circuits, each with a TFT switch, is used, multiple scanning lines through which scanning signals for switching the TFT switches to ON are outputted and multiple data lines through which data read out via the TFT switches are outputted are provided orthogonal to each other. This poses a problem that a parasitic capacity is formed at the intersection between each scanning line and data line, and noise is added to the readout signal due to the parasitic capacity, thereby the signal to noise ratio (S/N ratio) may be degraded. In the case where a size reduction in the pixel circuit is implemented, in particular, the numbers of the scanning lines and data lines are increased and the degradation in the S/N ratio of a signal read out from the detector becomes significant by that much. The degradation in the S/N ratio of a signal read out from the detector poses a problem of degradation in the image quality of the phase contrast image.

In view of the circumstances described above, it is an object of the present invention to provide a radiation image capturing apparatus and radiation image detector capable of obtaining a phase contrast image with a satisfactory quality by one image capturing operation without requiring a highly accurate moving mechanism.

### SUMMARY OF THE INVENTION

A radiation image capturing apparatus of the present invention is an apparatus, including:

a first grid which includes grid structures disposed at intervals and forms a first periodic pattern image by passing radiation emitted from a radiation source;

a second grid which includes grid structures disposed at intervals and forms a second periodic pattern image by receiving the first periodic pattern image;

a radiation image detector in which pixel circuits for detecting the second periodic pattern image formed by the second grid are disposed two-dimensionally; and

an image generation unit that generates a phase contrast image based on an image signal representing the second periodic pattern image detected by the radiation image detector, wherein:

either one of the first and second grids is a grid in which a plurality of unit grids is arranged, each unit grid corresponding to each of the pixel circuits, and at least three unit grids in a predetermined area corresponding to one pixel of the phase contrast image are disposed shifted in parallel with respect to the other grid by different distances in a direction perpendicular to an extending direction of the other grid;

the radiation image detector includes a plurality of arithmetic units for calculating at least two signals for generating the one pixel of the phase contrast image based on pixel signals read out from pixel circuits corresponding to the at least three unit grids in the predetermined area, the number of the signals being smaller than the number of the pixel signals; and

the image generation unit is a unit that generates the phase contrast image based on the signals outputted from the plurality of arithmetic units of the radiation image detector.

In the radiation image capturing apparatus of the present invention described above, each of the unit grids may be formed in a rectangular shape.

Further, images of the plurality of unit grids in the predetermined area may be disposed shifted in parallel with respect to the other grid in increments of P/M, where P is a pitch of the other grid and M is a predetermined number of pieces of phase information used for generating an image signal of one pixel of the phase contrast image.

Still further, pixel circuits corresponding to at least four unit grids in the predetermined area may be disposed point symmetrically.

Further, each of the arithmetic units may include a differential operation circuit for calculating a differential signal between pixel signals read out from pixel circuits corresponding to at least two unit grids in the predetermined area.

Still further, the image generation unit may be a unit that generates a pixel signal of one pixel of the phase contrast image based on a ratio between two signals outputted from two differential operation circuits respectively.

Further, each of the pixel circuits may include a switching element and a pixel signal of each pixel circuit may be read out by causing the switching element to be switched to ON, and a scanning line to which a scanning signal for switching each of the switching elements to ON may be provided at least every two rows of the pixel circuits.

Still further, the second grid may be a grid disposed at a Talbot interference distance from the first grid and intensity modulates the first periodic pattern image formed by the Talbot interference effect of the first grid.

Further, the first grid may be an absorption grid that forms the first periodic pattern image by passing the radiation as a projection image, and the second grid may be a grid that intensity modulates the first periodic pattern image as the projection image passed through the first grid.

Still further, the second grid may be disposed at a distance shorter than a minimum Talbot interference distance from the first grid.

A radiation image detector of the present invention is a detector in which pixel circuits for detecting an electric charge generated by receiving radiation are disposed two-dimensionally, wherein the detector includes a plurality of arithmetic units for calculating at least two signals based on pixel signals read out from at least three pixel circuits in a predetermined area, the number of the signals being smaller than the number of the pixel signals.

In the radiation image detector of the present invention described above, each of the arithmetic units may include a differential operation circuit for calculating a differential signal between pixel signals read out from at least two pixel circuits in the predetermined area.

Further, each of the pixel circuits may include a switching element and a pixel signal of each pixel circuit may be read out by causing the switching element to be switched to ON, and a scanning line to which a scanning signal for switching each of the switching elements to ON may be provided at least every two rows of the pixel circuits.

According to the radiation image capturing apparatus of the present invention, either one of the first and second grids is a grid in which a plurality of unit grids is arranged, each unit grid corresponding to each of the pixel circuits, and at least three unit grids in a predetermined area corresponding to one pixel of the phase contrast image are disposed shifted in parallel with respect to the other grid by different distances in a direction perpendicular to an extending direction of the other grid, and an image signal of one pixel of a phase contrast image is generated based on pixel signals read out from pixel circuits corresponding to the at least three unit grids. This allows a plurality of fringe images for obtaining a phase contrast image to be obtained by one image capturing operation without an accurate moving mechanism for moving the second grid required in the past.

Further, in the radiation image capturing apparatus of the present invention, the radiation image detector is provided with arithmetic units for calculating at least two signals for generating one pixel of the phase contrast image based on pixel signals read out from pixel circuits corresponding to the at least three unit grids in the predetermined area, the number of the image signals being smaller than the number of the pixel signals, and a phase contrast image is generated based on the signals outputted from the arithmetic units. This may reduce the amount of data for calculating a phase contrast image, whereby the arithmetic operation speed may be increased.

Further the provision of the arithmetic units allows image signals of at least three pixel circuits to be read out at the same time. Thus, for example, in the case where signals are read out from pixel circuits arranged in two rows by two columns or three rows by three columns at the same time, scanning lines to which a scanning signal for switching the switching element of each pixel circuit may be combined into one line. This, in turn, allows the parasitic capacity formed at the intersection between each scanning line and data line to be reduced, whereby the S/N ratio of signals may be improved and a phase contrast image with a satisfactory quality may be generated.

In particular, in the case where signals are read out from a greater number of pixel circuits than three rows by three columns at the same time and two signals are generated in the arithmetic units, the number of data lines may also be reduced and the S/N ratio of signals may further be improved.

### BRIEF DESCRIPTION OF THE DRAWINGS

FIG. 1 is a schematic configuration diagram of a radiation phase image capturing system that employs a first embodiment of the radiation image capturing apparatus of the present invention.

FIG. 2 is a top view of the radiation phase image capturing system shown in FIG. 1.

FIG. 3 schematically illustrates a configuration of a first grid.

FIG. 4 schematically illustrates a configuration of a second grid.

FIG. 5 is a partial cross-sectional view of the second grid.

FIG. 6 schematically illustrates a configuration of a unit grid of the first grid.

FIG. 7 illustrates, by way of example, a positional relationship between a self image of a unit grid member of each unit grid of the first grid and a grid member of the second grid.

FIG. 8 schematically illustrates a configuration of a TFT readout radiation image detector.

FIG. 9 illustrates, by way of example, a pixel circuit of the radiation image detector shown in FIG. 8.

FIG. 10 illustrates, by way of example, an arithmetic circuit of the pixel circuit shown in FIG. 9.

FIG. 11 illustrates, by way of example, a path of one radiation ray refracted according to a phase shift distribution Φ (x) in X direction of a subject.

FIG. 12 illustrates a fringe scanning method.

FIG. 13 illustrates a method of generating a phase contrast image.

FIG. 14 illustrates, by way of example, a positional relationship between a self image of a unit grid member of each unit grid of the first grid and a grid member of the second grid when one pixel of a phase contrast image is formed based on five pieces of phase information.

FIG. 15 illustrates, by way of example, a configuration of the pixel circuit when one pixel of a phase contrast image is formed based on five pieces of phase information.

### DESCRIPTION OF THE PREFERRED EMBODIMENTS

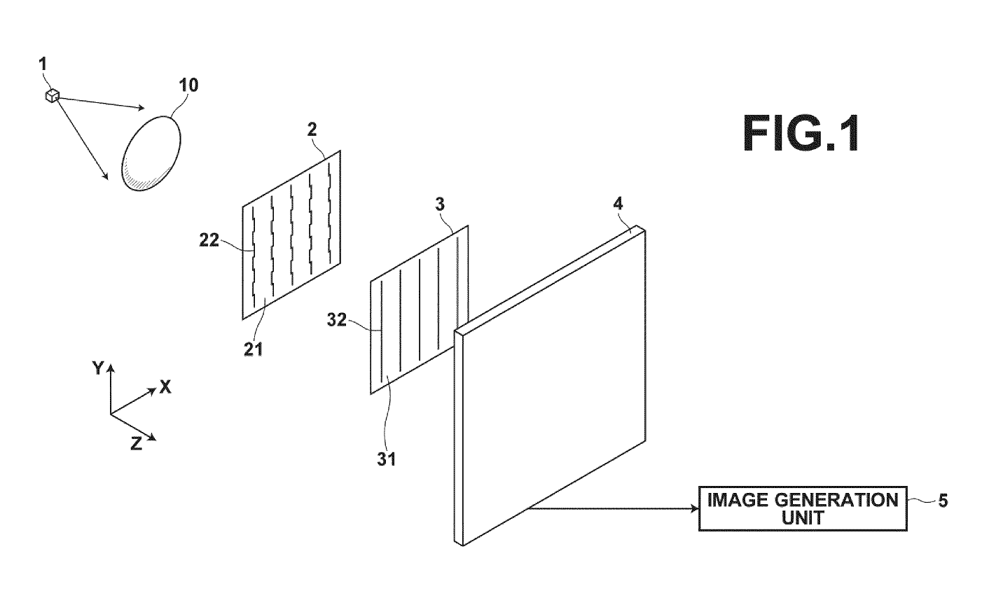

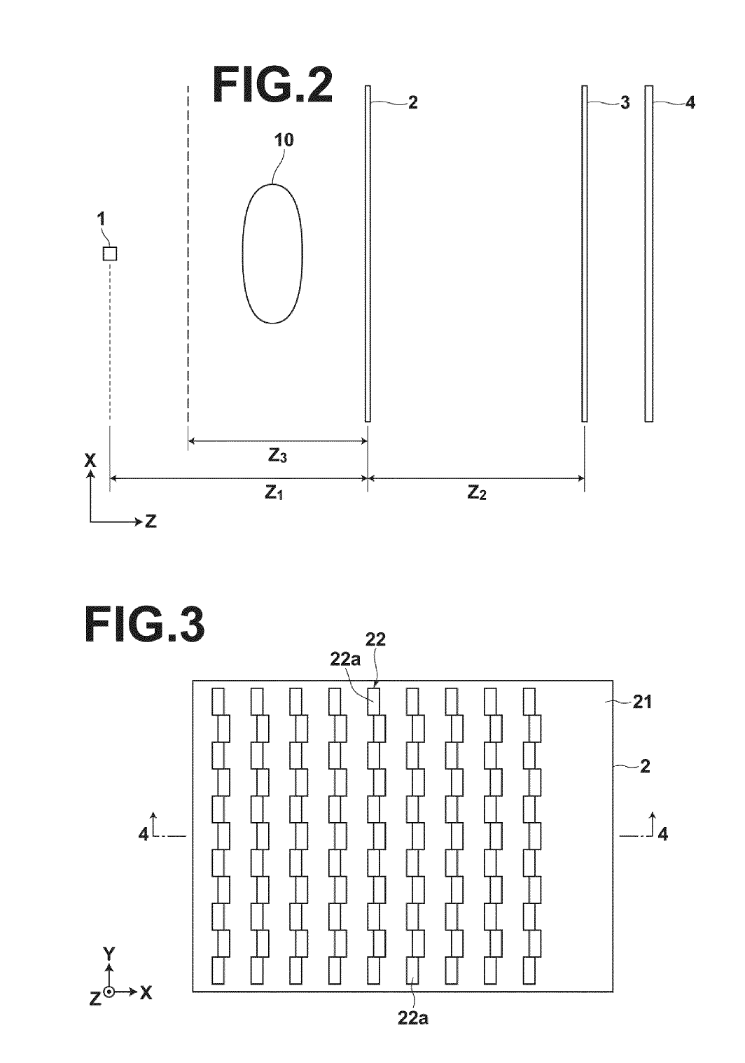

Hereinafter, a radiation phase image capturing system that employs a first embodiment of the radiation image capturing apparatus of the present invention will be described with reference to the accompanying drawings. FIG. 1 schematically illustrates a configuration of the radiation phase image capturing system of the first embodiment. FIG. 2 is a top view (X-Z cross-section) of the radiation phase image capturing system shown in FIG. 1. The thickness direction in FIG. 2 corresponds to Y direction in FIG. 1.

As shown in FIG. 1, the radiation phase image capturing system of the present embodiment includes radiation source 1 that emits radiation toward subject 10, first grid 2 that forms a first periodic pattern image (hereinafter, referred to as “self image”) by passing the radiation emitted from radiation source 1, second grid 3 that forms a second periodic pattern image by intensity modulating the first periodic pattern image formed by first grid 2, radiation image detector 4 that detects the second periodic pattern image formed by second grid 3, and image generation unit 5 that obtains a piece of phase information based on the second periodic pattern image detected by radiation image detector 4 and generates a phase contrast image based on the obtained piece of phase information.

Radiation source 1 emits radiation toward subject 10 and has enough spatial coherence to cause Talbot interference effect when radiation is incident on first grid 2. For example, a micro focus X-ray tube having a small radiation emission point or a plasma X-ray source may be used for this purpose. In the case where a radiation source having a relatively large radiation emission point (so-called focus spot size), like that used in general medical practice, is used, a multi-slit having a given pitch may be disposed on the emission side of the radiation. The detailed configuration in this case is described, for example, in “Phase retrieval and differential phase-contrast imaging with low-brilliance X-ray sources” by F. Pfeiffer, T. Weikamp, O. Bunk, and C. David, Nature Physics 2, Letters, pp. 258-261, and pitch P₀ of the slit MS should satisfy Formula (1) given below.

P₀=P₂×Z₃/Z₂ (1)

where, P₂ is a pitch of second grid 3, Z₃ is a distance from multi-slit MS to first grid 2 and Z₂ is a distance from first grid 2 to second grid 3 (FIG. 2).

As shown in FIG. 3, first grid 2 includes substrate 21 that primarily transmits radiation and grid members 22 provided on substrate 21. Each grid member 22 is formed of a plurality of unit grid members 22a disposed in Y direction and displaced in X direction by a predetermined pitch. In the present embodiment, X direction corresponds to a pixel row direction and Y direction corresponds to a pixel column direction of radiation image detector 4, to be described later. Note that FIG. 3 schematically illustrates each unit grid member 22a and the amount of displacement in X direction is not depicted accurately. The amount of displacement of each unit grid member 22a will be described in detail later.

Each unit grid member 22a constituting grid member 22 is a rectangular member extending in one in-plane direction perpendicular to the optical axis of the radiation (Y direction orthogonal to X and Z directions). As for the material of each unit grid member 22a, for example, a metal such as gold, platinum, or the like may be used. Preferably, first grid 2 is a so-called phase modulation grid that produces a phase modulation of about 90° or about 180° in the projected radiation. Assuming, for example, that each unit grid member 22a is made of gold, the thickness in Z direction in the energy range of X-ray used for general medical diagnosis is one to ten micrometers. Further, an amplitude modulation grid may also be used. In this case, each unit grid member 22a needs to have a thickness that allows sufficient absorption of radiation. Assuming, for example, that each unit grid member 22a is made of gold, the thickness h₁ of the member in the energy range of X ray used for general medical diagnosis is ten to several hundreds of micrometers.

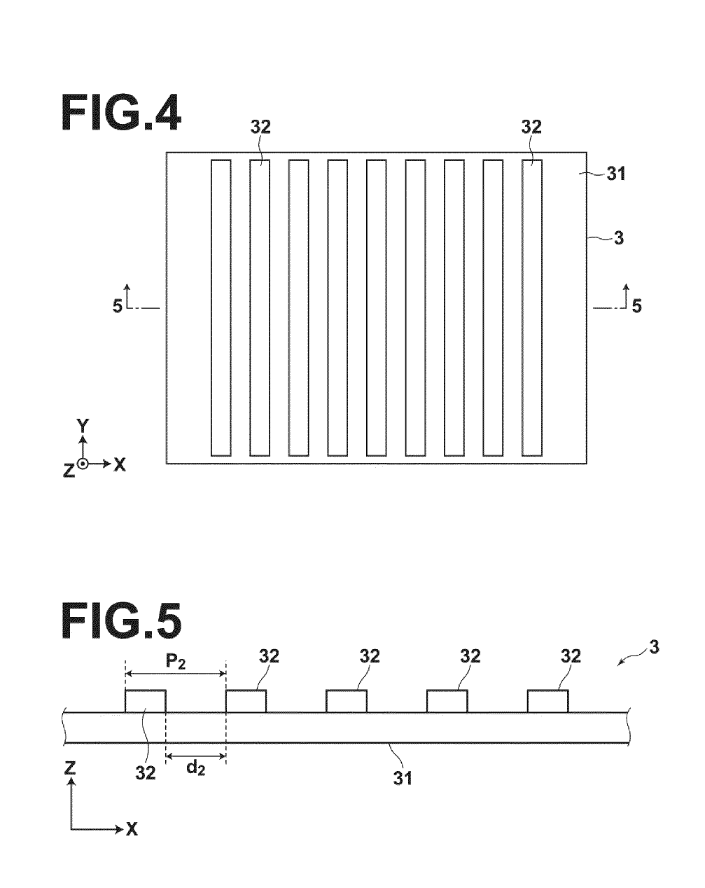

As shown in FIG. 4, second grid 3 includes substrate 31 that primarily transmits radiation, as in first grid 2, and a plurality of members 32 provided on substrate 31. The plurality of members 32 blocks radiation and each member 22 is a linear member extending in one in-plane direction orthogonal to the optical axis of radiation (Y direction orthogonal to X and Z directions).

FIG. 5 is a cross-sectional view of second grid 3 taken along the line 5-5 in FIG. 4. The plurality of grid members 32 is disposed in X direction at constant pitch P₂ with a predetermined distance d₂ between each member, as shown in FIG. 5. As for the material of the plurality of grid members 22, for example, a metal, such as gold, platinum, or the like may be used. Preferably, second grid 3 is an amplitude modulation grid. Each grid member 32 needs to have a thickness that allows sufficient absorption of radiation. Assuming, for example, that each grid member 32 is made of gold, the thickness of the member in the energy range of X ray used for general medical diagnosis is ten to several hundreds of micrometers.

In the present embodiment, a plurality of different pieces of phase information is obtained based on the second period pattern image detected by radiation image detector 4 and a phase contrast image is generated based on the plurality of different pieces of phase information. In the present embodiment, description will be made of a case in which four pieces of phase information is generated based on the second periodic pattern image and a phase contrast image is generated based on the four pieces of phase information.

A configuration of first grid 2 for generating four pieces of phase information will now be described in detail.

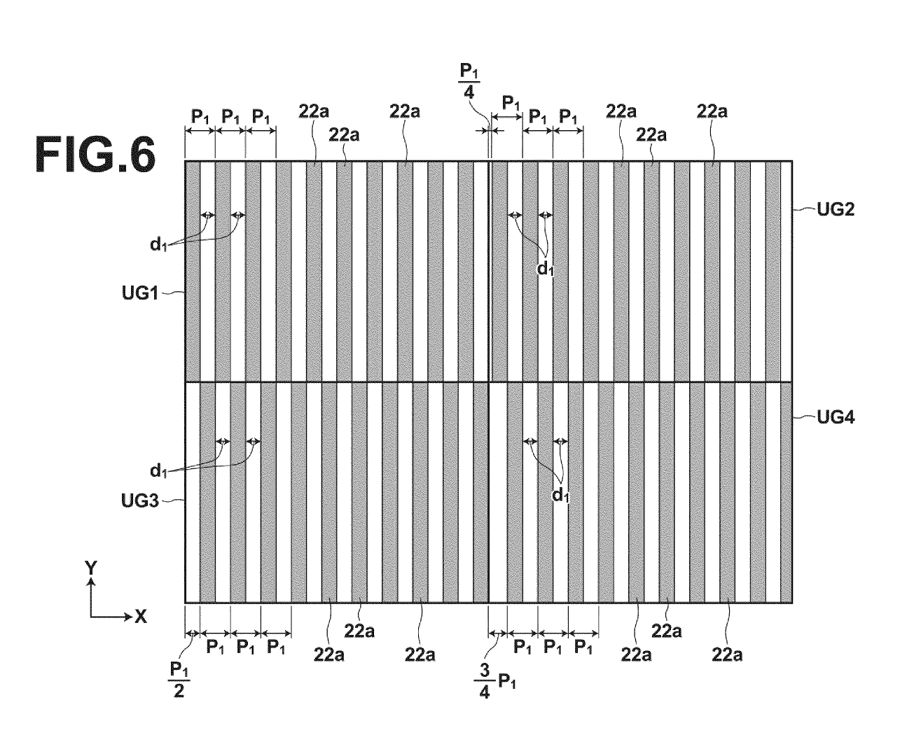

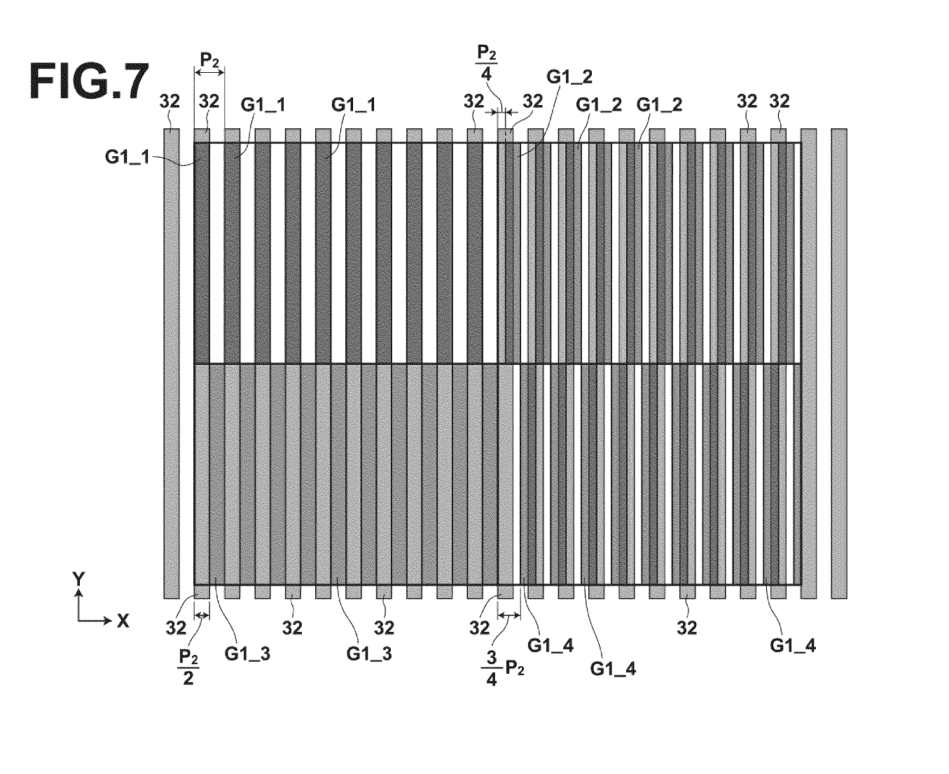

In the present embodiment, unit grid members 22a are disposed such that each of self images G1_1 to G1_4 of unit grid members 22a constituting each of adjacent unit grids in two row×two columns in X and Y directions transmits through second grid 3, and whereby each pixel signal of four pieces of phase information is generated. FIG. 6 illustrates adjacent unit grids UG1 to UG4 in two rows two columns, and FIG. 7 illustrates a positional relationship between each of self images G1_1 to G1_4 formed at the position of second grid 3 by the radiation transmitted through the unit grids UG1 to UG4 and each grid member 32.

Each of four self images G1_1 to G1_4 disposed in each of four rectangles indicated by solid lines in FIG. 7 is a self image of unit grid members 22a, constituting each of four unit grids UG1 to UG4. The four self images G1_1 to G1_4 in the four rectangles indicated by solid lines in FIG. 7 are disposed with different distances from the grid members 32 of second grid 3 in X direction.

More specifically, the upper left self image G1_1 of the four self images G1_1 to G1_4 is disposed with a distance of zero from grid members 32, the upper right self image G1_2 is disposed with a distance of P₂/4 from grid members 32, the lower left self image G1_3 is disposed with a distance of P₂/2 from grid members 32, and the lower right self image G1_4 is disposed with a distance of (3×P₂)/4. Here, P₂ is a pitch of grid members 32 of second grid 3 in an arrangement direction (X direction).

Each of the self images G1_1 to G1_4 of unit grid members 22a of four unit grids UG1 to UG4 disposed in the manner described above may be detected by each pixel circuit 40 of radiation image detector 4, to be described later, and pixel signals representing four pieces of phase information may be detected.

Here, the arrangement of the four unit grids UG1 to UG4 and the self images G1_1 to G1_4 has been described. In actuality, the arrangement of the four unit grids UG1 to UG4 and the self images G1_1 to G1_4 is repeated many times in X and Y directions.

Here, in the case where radiation emitted from radiation source 1 is a cone beam instead of a parallel beam, self images G1_1 to G1_4 of first grid 2 formed by radiation transmitted through first grid 2 are enlarged in proportion to the distance from radiation source 1. Consequently, the disposition of each unit grid members 22a of first grid 2 and grid pitch P₂ of second grid 3 are set by considering the magnification factor.

More specifically, if the distance from the focal point of radiation source 1 to first grid 2 is taken as Z₁ and the distance from first grid 2 to second grid 3 is taken as Z₂, in the case where the first grid 2 is a phase modulation grid that applies phase modulation of 90° or an amplitude modulation grid, the grid pitch P₁ of first grid 2 shown in FIG. 6 and grid pitch P₂ of second grid 3 shown in FIG. 7 are determined so as to satisfy the relationship of Formula (2) given below.

$${P}_{2} = {P}_{1}^{′} = \frac{{Z}_{1} + {Z}_{2}}{{Z}_{1}} {P}_{1} \qquad ( 2 )$$

where P₁′ is a pitch of self images G1_1 to G1_4 formed by the first grid 2 at the position of the second grid 3. Alternatively, in the case of the first grid 2 is a phase modulation grid that applies phase modulation of 180°, the pitch P₂ of the second grid is determined to satisfy the relationship of Formula (3) given below.

$${P}_{2} = {P}_{1}^{′} = \frac{{Z}_{1} + {Z}_{2}}{{Z}_{1}} \cdot \frac{{P}_{1}}{2} \qquad ( 3 )$$

In the case where radiation emitted from radiation source 1 is a parallel beam, then pitch P₂ of second grid 3 is determined so as to satisfy P₂=P₁, where the first grid 2 is a 90° phase modulation grid or an amplitude modulation grid, or P₂=P₁/2, where the first grid 2 is an 180° phase modulation grid.

Then, a radiation phase image capturing system capable of obtaining a phase contrast image is configured by radiation source 1, first grid 2, second grid 3, and radiation image detector 4, but in order the system to function as a Talbot interferometer, some other conditions may also be substantially satisfied, which will be described hereinafter.

First of all, the grid surfaces of first grid 2 and second grid 3 should be parallel to the X-Y plane shown in FIG. 1.

In the case where first grid 2 is a phase modulation grid that produces a phase modulation of 90°, the following condition should be substantially satisfied.

$${Z}_{2} = ( m + \frac{1}{2} ) \frac{{P}_{1} {P}_{2}}{λ} \qquad ( 4 )$$

where, λ is a wavelength of the radiation (normally, effective wavelength), m is 0 or a positive integer, P₁ is a pitch of unit grid members 22a of first grid 2 in X direction described above, and P₂ is a grid pitch of second grid 3 described above.

In the case where first grid 2 is a phase modulation grid that produces phase modulation of 180°, the following condition should be substantially satisfied.

$${Z}_{2} = ( m + \frac{1}{2} ) \frac{{P}_{1} {P}_{2}}{2 λ} \qquad ( 5 )$$

where, λ is a wavelength of the radiation (normally, effective wavelength), m is 0 or a positive integer, P₁ is a pitch of unit grid members 22a of first grid 2 in X direction described above, and P₂ is a grid pitch of second grid 3 described above.

In the case where first grid 2 is an amplitude modulation grid, the following condition should be substantially satisfied.

$${Z}_{2} = {m}^{′} \frac{{P}_{1} {P}_{2}}{λ} \qquad ( 6 )$$

where, λ is a wavelength of the radiation (normally, effective wavelength), m′ is a positive integer, P₁ is a pitch of unit grid members 22a of first grid 2 in X direction described above, and P₂ is a grid pitch of second grid 3 described above.

Formulae (4), (5), and (6) are applied to the case where radiation emitted from radiation source 1 is a cone beam, and if the radiation is a parallel beam, Formulae (7), (8), and (9) are applied instead of Formulae (4), (5), and (6) respectively.

$$\begin{matrix}{Z}_{2} = ( m + \frac{1}{2} ) \frac{{P}_{1}^{2}}{λ} & ( 7 ) \\ {Z}_{2} = ( m + \frac{1}{2} ) \frac{{P}_{1}^{2}}{4 λ} & ( 8 ) \\ {Z}_{2} = {m}^{′} \frac{{P}_{1}^{2}}{λ} & ( 9 )\end{matrix}$$

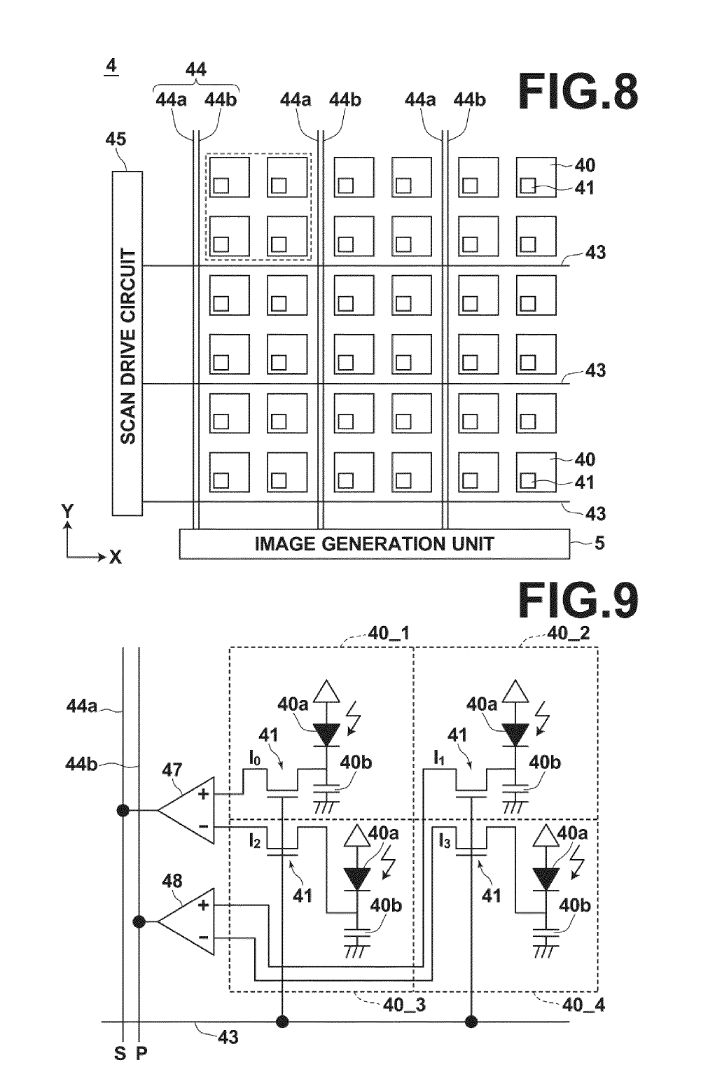

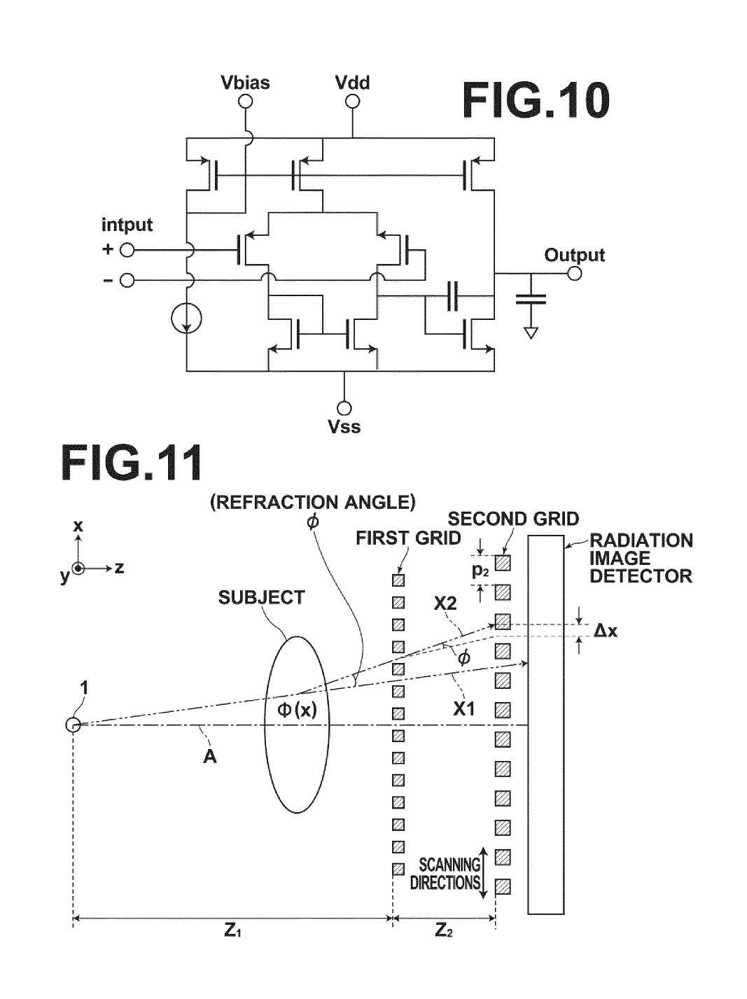

Radiation image detector 4 detects self images G1_1 to G1_4 of first grid 2 formed by the radiation incident on first grid 2 and intensity modulated by second grid 3 as image signals. As such radiation image detector 4, a so-called TFT readout radiation image detector in which pixel circuits 40, each having TFT (thin film transistor) switch 41, are disposed two-dimensionally, like that shown in FIG. 8, is used in the present embodiment.

Radiation image detector 4 includes multiple gate scanning lines 43 through which a scanning signal for switching TFT switch 41 of each pixel circuit 40 to ON/OFF is outputted and multiple data lines through which a pixel signal read out from each pixel circuit 40 via TFT switch 41 is outputted, in which gate scanning lines and data lines are provided perpendicular to each other.

As shown in FIG. 8, radiation image detector 4 of the present embodiment is provided with gate scanning line 43 for every two pixel circuit rows, and gate electrodes of TFT switches 41 of two pixel circuit rows are connected to one gate scanning line 43. Then, TFT switches of two pixel circuit rows are switched to ON at the same time by sending a scanning signal to one gate scanning line 43.

As shown in FIG. 8, each data line 44 is constituted by first data line 44a and second data line 44b, and provided for every two pixel circuit columns. First data line 44a is connected to one of the two pixel circuit columns and second data line 44b is connected to the other pixel circuit column. Although omitted in FIG. 8, an arithmetic circuit is provided between first data line 44a and the corresponding pixel circuit column, and between second data line 44b and the corresponding pixel circuit column. The arithmetic circuit will be described in detail later.

Multiple scanning lines 43 are connected to scan drive circuit 45 that outputs a scanning signal for switching TFT switch 41 of each pixel circuit to ON/OFF, while multiple data lines are connected to image generation unit 5.

In radiation image detector 4, a scanning signal is sequentially outputted from scan drive circuit 45 to each gate scanning line 43, then TFT switches 41 of two pixel circuit rows connected to each gate scanning line are sequentially switched to ON in response to the scanning signal, and pixel signals of every two pixel circuit rows are sequentially read out.

Then, the four self images G1_1 to G1_4 of unit grid members 22a shown in FIG. 7 are detected respectively by four pixel circuits in adjacent two rows×two columns in a rectangle of dotted line in FIG. 8. That is, a pixel signal of one pixel of a phase contrast image is generated based on the pixel signals detected by four pixel circuits 40 in the rectangle of dotted line in FIG. 8. In FIG. 8, only one group of four pixel circuits 40 corresponding to one pixel of a phase contrast image is indicated by the rectangle of dotted line, but each group of four pixel circuits 40 surrounded by each gate scanning line 43 and data line 44 is used for generating a pixel signal of one pixel of the phase contrast image.

Each pixel circuit 40 constituting radiation image detector 4 will now be described in detail.

FIG. 9 illustrates a detailed configuration of four pixel circuits 40 indicated by the rectangle of dotted line in FIG. 8. As shown in FIG. 9, each of pixel circuits 40_1 to 40_4 includes photoelectric conversion element 40a, storage section 40b for storing an electric charge converted by photoelectric conversion element 40a, and TFT switch 41 used for reading out a charge signal stored in the storage section 40b. Although omitted in FIG. 8, a wavelength conversion layer for converting emitted radiation to visible light is provided on pixel circuit 40, and photoelectric conversion element 40a photo-electrically converts the light emitted from the wavelength conversion layer to generate an electric charge.

The source electrode of TFT switch 41 of pixel circuit 40_1 corresponding to the self image G1_1 in FIG. 7 and the source electrode of TFT switch 41 of pixel circuit 40_3 corresponding to the self image G1_3 are connected to first arithmetic circuit 47 while the source electrode of TFT switch 41 of pixel circuit 40_2 corresponding to the self image G1_2 and the source electrode of TFT switch 41 of pixel circuit 40_4 corresponding to the self image G1_4 are connected to second arithmetic circuit 48.

First arithmetic circuit 47 subtracts a pixel signal I₂ detected by pixel circuit 40_3 from a pixel signal I₀ detected by pixel circuit 40_1 and outputs a differential signal S. The output terminal of first arithmetic circuit 47 is connected to first data line 44a and the differential signal S calculated by first arithmetic circuit 47 is outputted to first data line 44a.

Second arithmetic circuit 48 subtracts a pixel signal I₁ detected by pixel circuit 40_2 from a pixel signal I₃ detected by pixel circuit 40_4 and outputs a differential signal P. The output terminal of first arithmetic circuit 48 is connected to second data line 44b and the differential signal P calculated by second arithmetic circuit 48 is outputted to second data line 44b.

First arithmetic circuit 47 and second arithmetic circuit 48 may be configured, for example, by a differential amplifier. The configuration of a differential amplifier is known to public and will not be elaborated upon further here.

Image generation unit 5 generates a phase contrast image based on the differential signals S, P calculated in first and second arithmetic circuits 47, 48 according to image signals representing four pieces of phase information detected by radiation image detector 4. The method of generating the phase contrast image will be described in detail later.

An operation of the radiation phase image capturing system of the present embodiment will now be described.

First, subject 10 is placed between radiation source 1 and first grid 2, and radiation is emitted from radiation source 1, as shown in FIG. 1. The radiation emitted from radiation source 1 transmits through subject 10 and incident on first grid 2. The radiation incident on first grid 2 is diffracted by first grid 2 and a Talbot interference image is formed at a given distance from first grid 2 in the optical axis direction of the radiation.

This phenomenon is known as the Talbot effect, and self images G1_1 to G1_4 of first grid 2 are formed at given distances from first grid 2 when a light wave passes through first grid 2. For example, in the case where first grid 2 is a phase modulation grid that produces a phase modulation of 90°, a self image is formed at a distance given by Formula (4) or Formula (7) above (where first grid 2 is a phase modulation grid that produces a phase modulation of 180°, Formula (5) or Formula (8), and where first grid 2 is an intensity modulation grid, Formula (6) or Formula (9)), in which the wave-front incident on first grid 2 is distorted by subject 10 and, therefore, the self images G1_1 to G1_4 of first grid 2 are deformed accordingly. That is, each of the self images G1_1 to G1_4 of the unit grid members 22a is deformed by subject 10.

Thereafter, the radiation passes through second grid 3. As a result, each of the deformed self images G1_1 to G1_4 of the unit grid members 22a of first grid 2 is intensity modulated due to superimposition with second grid 3 and detected by radiation image detector 4 as an image signal reflecting the wave-front distortion described above.

Image detection in radiation image detector 4 and image reading from the detector will now be described.

Each of the self images G1_1 to G1_4 of the unit grid members 22a of first grid 2 deformed due to intensity modulation by second grid 3 in the manner described above is detected by each of the pixel circuits 40_1 to 40_4 shown in FIG. 9 and photo-electrically converted by the photoelectric conversion element 40a of each of the pixel circuits 40_1 to 40_4, whereby an electric charge generated by the photoelectric conversion is stored in the storage section 40b.

Then, scanning signals are sequentially outputted from scan drive circuit 45 to the gate scanning lines 43 disposed in Y direction and the electric charge stored in each pixel circuit 40 is read out as a pixel signal.

More specifically, when a scanning signal is outputted to the gate scanning line 43 shown in FIG. 9, TFT switches 41 of the four pixel circuits 40_1 to 40_4 are switched to ON at the same time.

This causes the pixel signal stored in the storage section 40b of the pixel circuit 40_1 and the pixel signal stored in the storage section 40b of the pixel circuit 40_3 to be read out via the TFT switches 41 and to be inputted to the first arithmetic circuit 47, while the pixel signal stored in the storage section 40b of the pixel circuit 40_2 and the pixel signal stored in the storage section 40b of the pixel circuit 40_4 to be read out via the TFT switches 41 and to be inputted to the second arithmetic circuit 48.

Then, a differential signal S is calculated by subtracting the image signal I₂ detected by the pixel circuit 40_3 from the pixel signal I₀ detected by the pixel circuit 40_1 in the first arithmetic circuit 47 and the differential signal S is outputted to the first data line 44a. Further, a differential signal P is calculated by subtracting the image signal I₃ detected by the pixel circuit 40_4 from the pixel signal I₁ detected by the pixel circuit 40_2 in the second arithmetic circuit 48 and the differential signal P is outputted to the second data line 44b.

Here, the operation of only the four pixel circuits 40_1 to 40_4 shown FIG. 9 has been described, but an identical operation is performed in each group of four pixel circuits 40_1 to 40_4 connected to the gate scanning line 43 shown in FIG. 9 and disposed in X direction.

This will result in that the differential signal S and differential signal P are calculated for each group of four pixel circuits 40_1 to 40_4. As will be described later, one pixel signal of a phase contrast image is generated based on the differential signal S and differential signal P, thus the scanning signal outputted to one gate scanning line 43 will cause signals of one pixel row of the phase contrast image to be read out.

Then scanning signals are sequentially outputted from scan drive circuit 45 to the gate scanning lines 43 disposed in Y direction to cause an operation identical to that described above to be sequentially performed, whereby pairs of differential signals S, P for one pixel row to be sequentially read out.

The differential signal S outputted to each first data line 44a and the differential signal P outputted to each second data line 44b are inputted to image generation unit 5 and image generation unit 5 generates a pixel signal of each pixel of a phase contrast image based on the inputted differential signal S and differential signal P.

Next, a method of generating a pixel signal of each pixel of a phase contrast image in image generation unit 5 based on the inputted differential signal S and differential signal P will be described. But, to begin with, the principle of a phase contrast image generation method based on a general fringe scanning method will be described.

FIG. 11 illustrates one radiation path refracted according to a phase shift distribution Φ(x) with respect to X direction of the subject. The reference symbol X1 denotes a straight path of the radiation in the absence of the subject, and the radiation ray propagating through the path X1 is incident on radiation image detector 4 after transmitting through first grid 2 and second grid 3. The reference symbol X2 denotes, in the case where the subject is present, a deflected radiation path due to refraction by the subject. The radiation propagating through the path X2 is blocked by second grid 3 after passing through first grid 2.

The phase shift distribution Φ(x) of the subject is expressed by Formula (10) given below taking n (x, z) as the refractive index distribution of the subject and z as the direction in which the radiation propagates. Here, y coordinate is omitted for the sake of convenience of explanation.

$$Φ ( x ) = \frac{2 π}{λ} \int [ 1 - n ( x , z ) ] d z \qquad ( 10 )$$

Self images G1_1 to G1_4 of first grid 2 formed at the position of second grid 3 is displaced in X direction due to refraction of the radiation ray at the subject in an amount according to the refraction angle φ. The amount of displacement Δx may be approximated by Formula (11) given below based on the fact that the refraction angle φ is very small.

Δx≈Z₂φ (11)

where, the refraction angle φ may be expressed by Formula (12) given below using wavelength λ of the radiation and phase shift distribution Φ (x) of the subject.

$$ϕ = \frac{λ}{2 π} \frac{\partial Φ ( x )}{\partial x} \qquad ( 12 )$$

As described above, the amount of displacement Δx of the self images G1_1 to G1_4 due to refraction of the radiation at the subject is linked to the phase shift distribution Φ (x). The amount of displacement Δx is linked to the phase shift amount Ψ of intensity modulated signal of each pixel (phase shift amount in intensity modulated signal of each pixel between the presence and absence of the subject) detected by radiation image detector 4 in the manner represented by Formula (13) given below.

$$ψ = \frac{2 π}{{P}_{2}} \\ Δ x = \frac{2 π}{{P}_{2}} {Z}_{2} ϕ \qquad ( 13 )$$

Accordingly, by obtaining the phase shift amount Ψ in the intensity modulated signal of each pixel, the refraction angle φ may be obtained by Formula (13), and a differential amount of the phase shift distribution Φ(x) may be obtained using Formula (12) given above. By integrating the differential amount with respect to x, the phase shift distribution. Φ(x) of the subject may be obtained, that is, the phase contrast image of the subject may be generated. The phase shift amount Ψ may be calculated by the fringe scanning method described below.

In the fringe scanning method, an image capturing operation described above is performed by translating either one of first grid 2 and second grid 3 relative to the other in X direction. Here, the description will be made of a case in which second grid 3 is moved. As second grid 3 is moved, the fringe image detected by radiation image detector 4 is moved and when a translation distance (movement amount in X direction) reaches one arrangement pitch of second grid 3 (arrangement pitch P₂), that is, when the phase variation between each of self images G1_1 to G1_4 of first grid 2 and second grid 3 reaches 2π, the fringe image returns to the original position. A fringe image is detected by radiation image detector 4 each time second grid 3 is moved by an amount of arrangement pitch P₂ divided by an integer, and intensity modulated signals of each pixel are obtained from a plurality of detected fringe images to obtain an phase shift amount Ψ in the intensity modulated signals of each pixel.

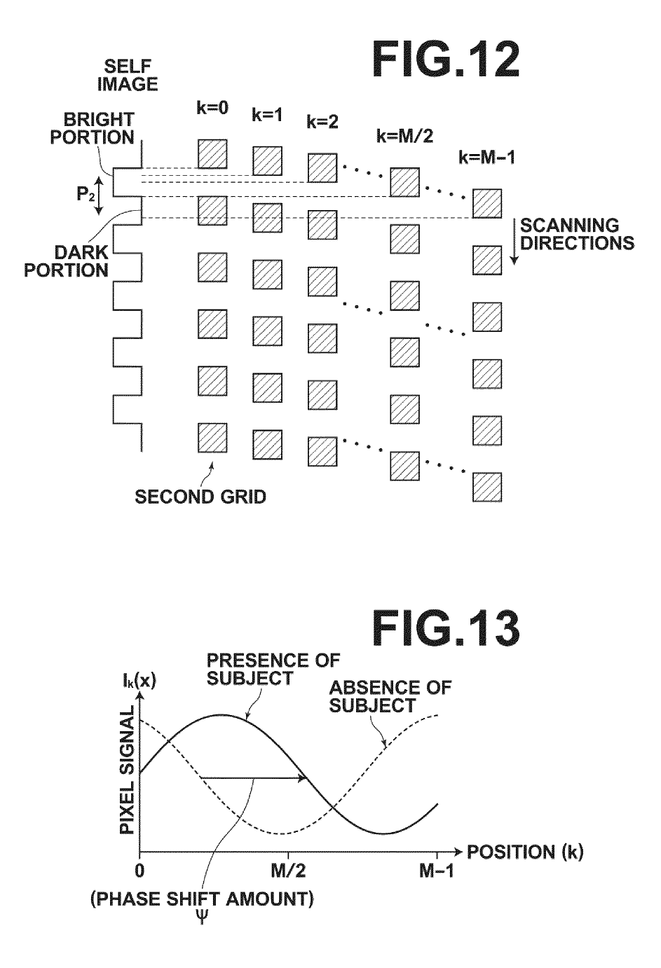

FIG. 12 schematically illustrates the movement of second grid 3 in increments of P₂/M, in which P₂ is the arrangement pitch of second grid 3 and M is an integer of two or greater.

At the position of K=0, the component of radiation not refracted by the subject is mainly passed through second grid 3. Then, as second grid 3 is sequentially moved to positions k=1, 2, - - - , the radiation component not refracted by the subject is decreased while the radiation component refracted by the subject is increased in the radiation passing through the second grid 3. In particular, at the position k=M/2, the radiation component refracted by the subject is mainly passed through second grid 3. Then, after the position k=M/2, the radiation component refracted by the subject is decreased while the radiation component not refracted by the subject is increased.

At each of the positions k=0, 1, 2, - - - , and M-1, an image capturing operation is performed using radiation image detector 4 to obtain image signals of M fringe images.

A method of calculating the phase shift amount Ψ of intensity modulated signal of each pixel from the pixel signal of each pixel of the fringe image signals of M fringe images.

First, the pixel signal Ik(x) of each pixel at the position k of second grid 3 may be represented by Formula (14) given below.

$${I}_{k} ( x ) = {A}_{0} + {\sum }_{n > 0} {A}_{n} exp [ 2 π i \frac{n}{{P}_{2}} \{ {Z}_{2} ϕ ( x ) + \frac{{kP}_{2}}{M} \} ] \qquad ( 14 )$$

where, x is the coordinate of the pixel in x direction, A₀ is the intensity of incident radiation, and Aₙ is the value corresponding to the contrast of the intensity modulated signal (n is a positive integer, here). The φ(x) is the representation of the refraction angle φ as a function of the coordinate x of the pixel of radiation image detector 4.

Then, the use of the relationship represented by Formula (15) given below may result in that the refraction angle φ(x) is expressed as Formula (16) given below.

$$\begin{matrix}{\sum }_{k = 0}^{M - 1} exp ( - 2 π i \frac{k}{M} ) = 0 & ( 15 ) \\ ϕ ( x ) = \frac{{P}_{2}}{2 π {Z}_{2}} arg [ {\sum }_{k = 0}^{M - 1} {I}_{k} ( x ) exp ( - 2 π i \frac{k}{M} ) ] & ( 16 )\end{matrix}$$

where, arg[ ] implies extraction of an argument corresponding to the phase shift amount Ψ of each pixel of radiation image detector 4. Therefore, the refraction angle φ(x) may be obtained by calculating the phase shift amount Ψ of intensity modulated signal of each pixel of the phase contrast image from M pixel signals of fringe image signals obtained for each pixel based on Formula (16).

More specifically, as illustrated in FIG. 13, the M pixel signals obtained from each pixel of radiation image detector 4 varies periodically with respect to the position k of radiation image detector 4 with the grid pitch P₂ of second grid 3. The broken line in FIG. 13 indicates a pixel signal variation in the absence of the subject while the solid line indicates a pixel signal variation in the presence of the subject. The phase difference between the two waveforms corresponds to the phase shift amount Ψ of intensity modulated signal of each pixel.

As the refraction angle φ(x) is a value corresponding to a differential value of the phase shift distribution Φ(x) as indicated by Formula (12) above, the phase shift distribution Φ(x) may be obtained as a phase contrast image by integrating the refraction angle φ(x) along x axis.

So far, a phase contrast image generation method based on a general fringe scanning method has been described. Here, Formula (16) representing the refraction angle φ(x) may be represented by Formula (17) given below.

$$ϕ ( x ) ∝ A \cdot arg [ \frac{{\sum }_{k = 0}^{M - 1} {I}_{k} sin {δ}_{k}}{{\sum }_{k = 0}^{M - 1} {I}_{k} cos {δ}_{k}} ] . \qquad ( 17 )$$

Here, as δₖ may be represented by Formula (18) given below, the expression in the brackets of Formula (17) may be calculated as Formula (19) and may be expressed as Formula (20) given below if taking M as 4, the image signal detected by pixel circuit 40_1 as I₀, image signal detected by pixel circuit 40_2 as I₁, image signal detected by pixel circuit 40_3 as I₂, and image signal detected by pixel circuit 40_4 as I₃, as in the present embodiment. The phases at k=0, 1, 2, and 3 are shifted by 0, π/2, π, and 3π/2 respectively and pixel circuits 40_1, 40_2, 40_3, and 40_4 correspond to them respectively.

$$\begin{matrix}\begin{matrix}{δ}_{k} = \frac{2 π k}{M} \\ \frac{{I}_{0} sin \frac{2 π \cdot 0}{4} + {I}_{1} sin \frac{2 π \cdot 1}{4} + {I}_{2} sin \frac{2 π \cdot 2}{4} + {I}_{3} sin \frac{2 π \cdot 3}{4}}{{I}_{0} cos \frac{2 π \cdot 0}{4} + {I}_{1} cos \frac{2 π \cdot 1}{4} + {I}_{2} cos \frac{2 π \cdot 2}{4} + {I}_{3} cos \frac{2 π \cdot 3}{4}} \\ = \frac{{I}_{0} \cdot 0 + {I}_{1} \cdot 1 + {I}_{2} \cdot 0 + {I}_{3} \cdot ( - 1 )}{{I}_{0} \cdot 1 + {I}_{1} \cdot 0 + {I}_{2} \cdot ( - 1 ) + {I}_{3} \cdot 0} \\ = \frac{{I}_{1} - {I}_{3}}{{I}_{0} - {I}_{2}}\end{matrix} & \begin{matrix}( 18 ) \\ \begin{matrix}\begin{matrix}\begin{matrix}\begin{matrix}\begin{matrix}\begin{matrix}\begin{matrix} \\ \end{matrix} \\ \end{matrix} \\ \end{matrix} \\ \end{matrix} \\ \end{matrix} \\ \end{matrix} \\ ( 19 )\end{matrix}\end{matrix} \\ ϕ ( x ) ∝ A \cdot arg [ \frac{{I}_{1} - {I}_{3}}{{I}_{0} - {I}_{2 }} ] & ( 20 )\end{matrix}$$

That is, Formula (17) may be represented as Formula (21) given below using the differential signal P and differential signal S.

$$ϕ ( x ) ∝ A \cdot arg [ \frac{p}{s} ] \qquad ( 21 )$$

Thus, image generation unit 5 generates a pixel signal of each pixel of a phase contrast image by calculating Formula (21) based on the differential signal S and differential signal P inputted therein in the manner as described above.

The two-dimensional distribution of refraction angles φ(x, y) or two-dimensional distribution of phase shift amounts Ψ(x, y) is known as a phase differential image as they correspond to differential values of phase shift distribution Φ(x, y), and the phase differential image may be generated as the phase contrast image.

According to the radiation phase image capturing system of the first embodiment described above, first grid 2 is formed of a plurality of unit grids, and each of four unit grids in a predetermined area corresponding to one pixel of a phase contrast image is disposed shifted in parallel with respect to second grid 3 by a different distance from each other. Then, based on pixel signals read out from pixel circuits 40_1 to 40_4 corresponding to four unit grids, a pixel signal of one pixel constituting a phase contrast image is generated. This allows a plurality of fringe images for generating a phase contrast image to be obtained by one image capturing operation without an accurate moving mechanism for moving the second grid required in the past.

Further, first and second arithmetic circuits 47, 48 that calculate two signals for generating one pixel of a phase contrast image based on the pixel signals read out from the pixel circuits 40_1 to 40_4 corresponding to four unit grids are provided in radiation image detector 4, and the phase contrast image is generated based on the two signals. This may reduce the amount of data outputted from radiation image detector 4 in half and, whereby, the arithmetic operation speed for generating a phase contrast image may be increased.

Still further, the provision of first and second arithmetic circuits 47, 48 allows image signals of four pixel circuits to be read out at the same time, so that gate scanning lines 43 of four pixel circuits may be combined into one gate scanning line 43. This, in turn, allows the parasitic capacity formed at the intersection between each scanning line 43 and data line 44 to be reduced, whereby the S/N ratio of signals may be improved and a phase contrast image with a satisfactory quality may be generated.

Next, a radiation phase image capturing system that employs a second embodiment of the radiation image capturing apparatus of the present invention will be described. In the first embodiment described above, four pieces of phase information is detected by four pixel circuits 40_1 to 40_4 and a pixel signal of each pixel of a phase contrast image is generated from the four pixel signals, but the number of pieces of phase information is not limited to four and it may be three or more. The radiation phase image capturing system of the second embodiment generates a phase contrast image from five pieces of phase information. Note that only a configuration different from that of the radiation phase image capturing system of the first embodiment will be described here.

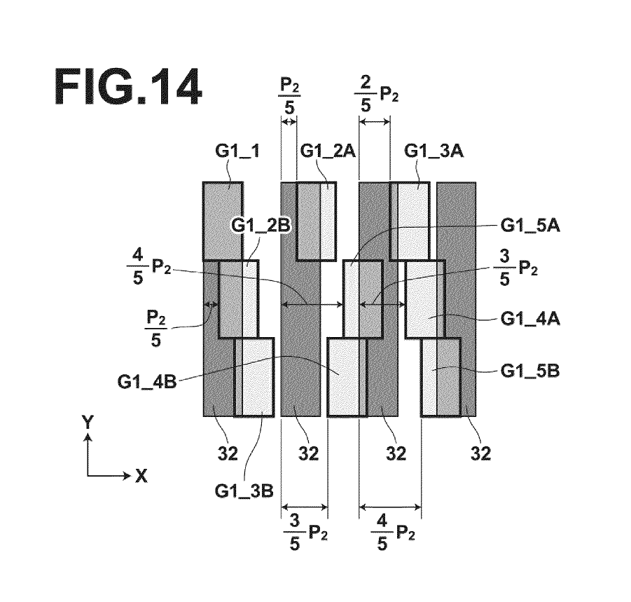

An arrangement of each unit grid member 22a of first grid 2 in the radiation phase image capturing system of the second embodiment will be described first. FIG. 14 illustrates a positional relationship between each of self images G1_1, G1_2A, G1_2B, G1_3A, G1_3B, G1_4A, G1_4B, G1_5A, and G1_5B of each unit grid member 22a formed at second grid 3 by the transmission of radiation through first grid 2 and each grid member 32 of second grid 3.

In the present embodiment, unit grid members 22a disposed such that each of self images G1_1 to G1_5B of unit grid member 22a constituting each of adjacent unit grids in three row×three columns in X and Y directions transmits through second grid 3, and whereby each pixel signal of five pieces of phase information is generated. FIG. 14 illustrates the relationship between only one grid member 32 of second grid 3 and self images G1_1 to G1_5B of one unit grid member 22a with respect to each unit grid. In actuality, however, each unit grid includes multiple grid members 32 and self images G1_1 to G1_5B of unit gird members 22a, as in the case of the unit grids of two row×two columns shown in FIG. 7.

More specifically, as illustrated in FIG. 14, a self image G1_1 in the first row, first column of nine self images G1_1 to G1_5B of three row×three columns is disposed with a distance of zero from the grid member 32, self images G1_2A, G1_2B in the first row, second column and in the second row, first column respectively are disposed with a distance of P₂/5 from the corresponding grid members 32, self images G1_3A, G1_3B in the first row, third column and in the second row, in the third row, first column respectively are disposed with a distance of (2×P₂)/5 from the corresponding grid members 32, self images G1_4A, G1_4B in the second row, third column and third row, second column respectively are disposed with a distance of (3×P₂)/5 from the corresponding grid members 32, and self images G1_5A, G1_5B in the second row, second column and third row, third column respectively are disposed with a distance of (4×P₂)/5 from the corresponding grid members 32. Here, P₂ is the pitch of grid members 32 in the arrangement direction (X direction), as described above.

By detecting the self images G1_1 to G1_5B of unit grid members 22a in the nine unit grids disposed in the manner described above by each pixel circuit 40 of radiation image detector 4, each pixel signal of five pieces of phase information may be detected. Here, the self image G1_1 represents a first piece of phase information, self images G1_2A and G1_2B represent a second piece of phase information, self images G1_3A and G1_3B represent a third piece of phase information, self images G1_4A and G1_4B represent a fourth piece of phase information, and self images G1_5A and G1_5B represent a fifth piece of phase information.

Here, only nine self images G1_1 to G1_5B have been described, but the arrangement of nine self images G1_1 to G1_5B is repeated in X and Y directions.

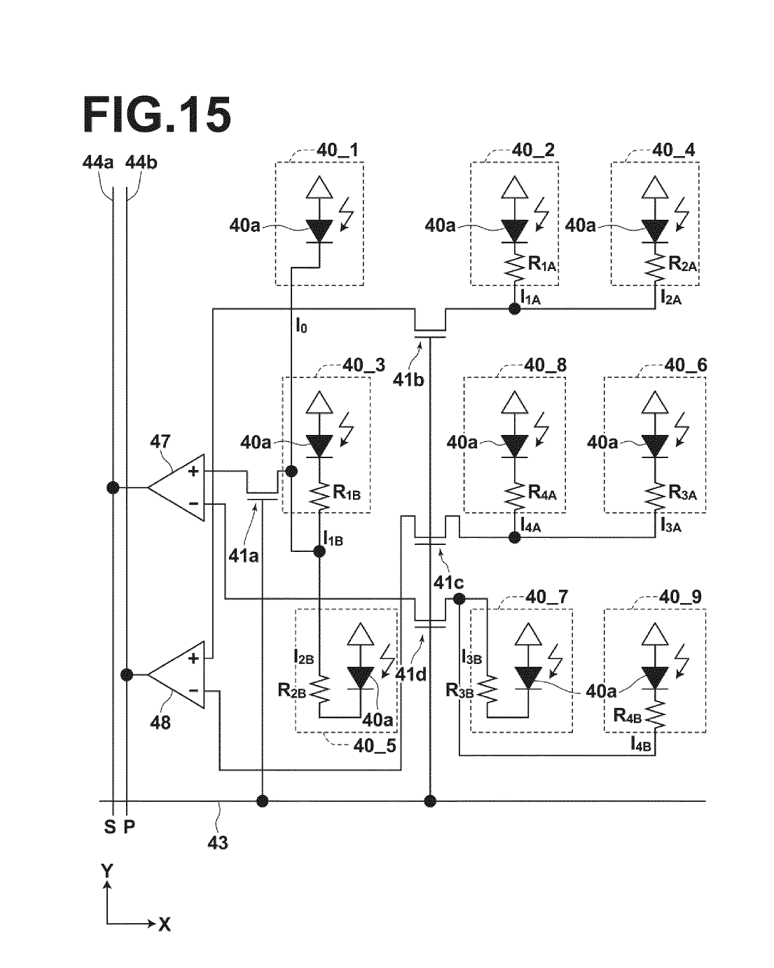

Then, the self images G1_1 to G1_5B of unit grid members 22a in the nine unit grids shown in FIG. 14 are detected respectively by nine pixel circuits 40_1 to 40_9 in 3×3 arrangement. That is, a pixel signal of one pixel of a phase contrast image is generated based on the pixel signals detected by the nine pixel circuits 40_1 to 40_9. FIG. 15 depicts only nine pixel circuits 40_1 to 40_9 corresponding to one pixel of a phase contrast image, but such group of nine pixel circuits is disposed repeatedly in X and Y directions. A gate scanning line 43 is provided every three pixel circuit rows, while first and second data lines 44a, 44b are provided every three pixel circuit columns.

As illustrated in FIG. 5, each of the pixel circuits 40_1 to 40_9 includes a photoelectric conversion element 40a and a pixel signal of one pixel of a phase contrast image is generated based on a charge signal generated by each photoelectric conversion element 40a. Here, Formula (17) may be expressed as Formula (22) given below.

$$ϕ ( x ) ∝ A \cdot arg [ \frac{\begin{matrix}{I}_{0} sin \frac{π \cdot 0}{5} + {I}_{1} sin \frac{π \cdot 1}{5} + \\ {I}_{2} sin \frac{π \cdot 2}{5} + {I}_{3} sin \frac{π \cdot 3}{5} + {I}_{4} sin \frac{π \cdot 4}{5}\end{matrix}}{\begin{matrix}{I}_{0} cos \frac{π \cdot 0}{5} + {I}_{1} cos \frac{π \cdot 1}{5} + \\ {I}_{2} cos \frac{π \cdot 2}{5} + {I}_{3} cos \frac{π \cdot 3}{5} + {I}_{4} cos \frac{π \cdot 4}{5}\end{matrix}} ] ∝ A \cdot arg [ \frac{\begin{matrix}{I}_{0} \cdot 0 + {I}_{1} \cdot 0.95 + {I}_{2} \cdot 0.59 + \\ {I}_{3} \cdot ( - 0.59 ) + {I}_{4} \cdot ( - 0.95 )\end{matrix}}{\begin{matrix}{I}_{0} \cdot 1 + {I}_{1} \cdot 0.79 + {I}_{2} \cdot 0.24 + \\ {I}_{3} \cdot ( - 0.41 ) + {I}_{4} \cdot ( - 0.88 )\end{matrix}} ] ∝ A \cdot arg [ \frac{{I}_{1 A} + {I}_{2 A} - {I}_{3 A} - {I}_{4 A}}{{I}_{0} + {I}_{1 B} + {I}_{2 B} - {I}_{3 B} - {I}_{4 B}} ] \qquad ( 22 )$$

In the present embodiment, M=5 and the numerator in the brackets is the sum of I₁ to I₄, excluding I₀, multiplied by respective coefficients and the denominator is the sum of I₀ to I₄ multiplied by respective coefficients in Formula (17) above. That is, there are nine terms, four terms in the numerator and five terms in the denominator. In the present embodiment, nine pixel circuits 40_1 to 40_9 in three rows×three columns are used to generate a pixel signal of one pixel of a phase contrast image, and each term is allocated to each of the nine pixel circuits 40_1 to 40_9. That is, the pixel signal of the pixel circuit 40_1 that detects the self image G1_1 at k=0 is allocated to I₀, the pixel signals of the pixel circuits 40_2 and 40_3 that detect self images G1_2A and G1_2B at k=1 are allocated to I_{1A}, I_{1B} which are I₁ in the numerator and denominator respectively multiplied by the respective coefficients, the pixel signals of the pixel circuits 40_4 and 40_5 that detect self images G1_3A and G1_3B at k=2 are allocated to I_{2A}, I_{2B} which are I₂ in the numerator and denominator respectively multiplied by the respective coefficients, the pixel signals of the pixel circuits 40_6 and 40_7 that detect self images G1_4A and G1_4B at k=3 are allocated to I_{3A}, I_{3B} which are I₃ in the numerator and denominator respectively multiplied by the respective coefficients, and the pixel signals of the pixel circuits 40_8 and 40_9 that detect self images G1_5A and G1_5B at k=4 are allocated to I_{4A}, I_{4B} which are I₄ in the numerator and denominator respectively multiplied by the respective coefficients. That is, the suffix A indicates numerator side and suffix B indicates denominator side. The value of each coefficient multiplied with each of I₀ to I₄ is smaller than one. Resistors R1A to R4B are connected respectively to photoelectric conversion elements 40a in series, and the value of each of resistors R1A to R4B is adjusted so as to correspond to the coefficient of the signal obtained by each photoelectric conversion element 40a. Positive/negative calculations are implemented by selecting the connection terminals of the first and second arithmetic circuits 47, 48.

In the first embodiment described above, each of the pixel circuits 40_1 to 40_4 is provided with the storage section 40b for storing an electric charge generated by each photoelectric conversion element 40a, but the storage section 40b is not necessarily required, and present embodiment uses pixel circuits without a storage section.

Further, each of the pixel circuits 40_1 to 40_4 is provided with a TFT switch 41 in the first embodiment, but in the present embodiment, one TFT switch is shared by a plurality of pixel circuits such that the calculation of Formula (22) is performed. More specifically, as shown in FIG. 15, the TFT switch 41a is used for reading out electric charges generated by photoelectric conversion elements 40a in the pixel circuits 40_1, 40_3, and 40_5, the TFT switch 41b is used for reading out electric charges generated by photoelectric conversion elements 40a in the pixel circuits 40_2 and 40_4, the TFT switch 41c is used for reading out electric charges generated by photoelectric conversion elements 40a in the pixel circuits 40_6 and 40_8, and the TFT switch 41d is used for reading out electric charges generated by photoelectric conversion elements 40a in the pixel circuits 40_7 and 40_9.

In order to perform the calculation of Formula (22) above, the source electrodes of TFT switches 41a, 41d are connected to first arithmetic circuit 47, while the source electrodes of TFT switches 41b, 41c are connected to second arithmetic circuit 48.

First arithmetic circuit 47 of the present embodiment calculates I₀+I_{1B}+I_{2B}−I_{3B}−I_{4B} in Formula (22) to output a differential signal S, while second arithmetic circuit 48 calculates I_{1A}+I_{2A}−I_{3A}−I₄, in Formula (22) to output a differential signal P.

Image generation unit 5 of the present embodiment generates a phase contrast image based on the differential signal S calculated by first arithmetic circuit 47 and differential signal P calculated by second arithmetic circuit 48 based on image signals of the five pieces of phase information detected by radiation image detector 4.

An operation of the radiation phase image capturing system of the present embodiment will now be described.

Operation steps until which radiation transmitted through subject 10 is passed through first grid 2 and second grid 3 to form self images G1_1 to G1_5B of first grid 2 intensity modulated by second grid 3 and the self images G1_1 to G1_5B are detected by radiation image detector 4 are identical to those of the first embodiment.

Then, in the present embodiment, the self images G1_1 to G1_5B shown in FIG. 14 are detected respectively by the pixel circuits 40_1 to 40_9 of radiation image detector 4 shown in FIG. 15 and photo-electrically converted respectively by photoelectric conversion elements 40a of the pixel circuits 40_1 to 409.

Then, scanning signals are sequentially outputted from scan drive circuit 45 to the gate scanning lines 43 disposed in Y direction and an electric charge generated in each pixel circuit 40 is read out as a pixel signal.

More specifically, when a scanning signal is outputted to the gate scanning line 43 shown in FIG. 15, the TFT switches 41a to 41d connected to the gate scanning line 43 are switched to ON at the same time.

This causes the pixel signal I0 of the pixel circuit 40_1, the pixel signal I1B of the pixel circuit 40_3 and pixel signal I2B of the pixel circuit 40_5 to be read out via the TFT switch 41a and inputted to first arithmetic circuit 47, while the pixel signal I3B of pixel circuit 40_7 and pixel signal I4B of pixel circuit 40_9 to be read out via the TFT switch 41d and inputted to first arithmetic circuit 47.

Then, in the first arithmetic circuit 47, the calculation of I0+I1B+I2B−I3B−I4B in Formula (22) is performed to generate the differential signal S and the differential signal S is outputted to the first data line 44a.

Further, the pixel signal I1A of the pixel circuit 40_2 and the pixel signal I2A of the pixel circuit 40_4 are read out via the TFT switch 41b and inputted to the second arithmetic circuit 48, while the pixel signal I3A of the pixel circuit 40_6 and pixel signal I4A are read out via the TFT switch 41c and inputted to the second arithmetic circuit 48.

Then, in the second arithmetic circuit 48, the calculation of I_{1A}−I_{2A}−I_{3A}−I_{4A} in Formula (22) is performed to generate the differential signal P and the differential signal P is outputted to the second data line 44b.

Here, the operation of only the nine pixel circuits 40_1 to 40_9 shown in FIG. 15 has been described, but an identical operation is performed in each group of nine pixel circuits 40_1 to 40_9 connected to the gate scanning line 43 shown in FIG. 15 and disposed in X direction.

This will result in that the differential signal S and differential signal P are calculated for each group of nine pixel circuits 40_1 to 40_9.

Then scanning signals are sequentially outputted from scan drive circuit 45 to the gate scanning lines 43 disposed in Y direction to cause an operation identical to that described above to be sequentially performed, whereby pairs of differential signals S, P for one pixel row to be sequentially read out.

The differential signal S outputted to each first data line 44a and the differential signal P outputted to each second data line 44b are inputted to image generation unit 5 and image generation unit 5 generates a pixel signal of each pixel of a phase contrast image based on the inputted differential signal S and differential signal P.

More specifically, image generation unit 5 generates a pixel signal of each pixel of a phase contrast image by calculating Formula (21) based on the differential signal S and differential signal P inputted therein, as in the first embodiment.

According to the radiation phase image capturing system of the second embodiment described above, radiation image detector 4 is provided with the first and second arithmetic circuits 47, 48 that calculate two signals for generating one pixel of a phase contrast image based on pixel signals read out from pixel circuits 40_1 to 40_9 corresponding to nine groups of unit grid members 22a, and a phase contrast image is generated based on the two signals. This requires only two signals, instead of nine signals required in the past, to be outputted from radiation image detector 4 for generating one pixel of a phase contrast image, whereby the amount of data outputted from radiation image detector 4 may be reduced and the arithmetic operation speed for generating a phase contrast image may be increased.

Still further, the provision of first and second arithmetic circuits 47, 48 allows image signals of nine pixel circuits to be read out at the same time, so that gate scanning lines 43 of nine pixel circuits may be combined into one gate scanning line 43. This, in turn, allows the parasitic capacity formed at the intersection between each scanning line 43 and data line 44 to be reduced, whereby the S/N ratio of signals may be improved and a phase contrast image with a satisfactory quality may be generated.

In the radiation phase image capturing system of the first and second embodiments, any one of Formulae (4) to (9) are satisfied such that the distance Z₂ from the first grid 2 to second grid 3 becomes the Talbot interference distance, but a configuration may be adopted in which first grid 2 projects the incident radiation without diffraction. Such configuration will result in that a projection image projected through first grid 2 may be obtained analogously at any position behind first grid 2, so that the distance Z₂ from the first grid 2 to second grid 3 may be set independently of the Talbot interference distance.

More specifically, first grid 2 and second grid 3 are formed as absorption (amplitude modulation) grids and such that radiation passed through the slit sections thereof is projected geometrically, regardless of the Talbot effect. More particularly, most of the incident radiation may be straightly passed through the slit sections without being diffracted by setting the distance d₁ between each member of first grid 2 and the distance d₂ between each member of second grid 3 to a value sufficiently larger than the peak wavelength of radiation emitted from radiation source 1. For example, in the case of the radiation source with a tungsten target, the effective wavelength of the radiation is about 0.4 Å at a tube voltage of 50 kV. In this case, if the distance d₁ between each member of first grid 2 and the distance d₂ between each member of second grid 3 are set to a value from 1 μm to 10 μm, most of the radiation is geometrically projected without being diffracted by the slit.

The relationship between grid pitch P₁ of first grid 2 and grid pitch P₂ of second grid 3 is identical to that of the first embodiment. Further, the arrangement of unit grid members 22a constituting first grid 2 with respect to second grid 3 is also identical to that of first embodiment.

In this case, the distance Z₂ between first grid 2 and second grid 3 may be set to a value smaller than the minimum Talbot interference distance calculated by Formula (6) given above when 1 is substituted to m′ (m′=1). That is, the distance Z₂ is set to a value that satisfies Formula (23) given below.

$${Z}_{2} < \frac{{P}_{1} {P}_{2}}{λ} \qquad ( 23 )$$

Preferably, the unit grid members 22a of first grid 2 and grid members 32 of second grid 3 completely block (absorb) radiation in order to generate a high contrast periodic pattern image. But radiation transmitting therethrough without being absorbed may present in no small amount even if a material excellent in radiation absorption (gold, platinum, or the like) is used. Therefore, in order to improve radiation blocking capability, it is preferable that the thicknesses h₁, h₂ of the unit grid members 22a and grid members 23 are as thick as possible. Preferably, radiation blocking of the unit grid members 22a and grid members 32 is not less than 90% of the incident radiation. For example, in the case where the tube voltage of radiation source 1 is 50 kV, it is preferable that the thicknesses h₁, h₂ are not less than 100 μm in terms of gold (Au).

If the radiation phase image capturing system is configured in the manner as described above, the distance Z₂ from first grid 2 to second grid 3 may be made smaller than the Talbot interference distance so that the system may be made thinner in comparison with the radiation phase image capturing system of the first and second embodiments that require a certain Talbot interference distance.

In the embodiments described above, the radiation phase image capturing system uses a radiation image detector that employs TFT switches as radiation image detector 4, but a radiation image detector that employs CMOS sensors may also be used.

Preferably, pixel circuits that detect a plurality of self images of unit grid members 22a used for generating one pixel of a phase contrast image are disposed point symmetrically as in the radiation phase image capturing system of the embodiments described above. But, the radiation image capturing apparatus of the present invention is not limited to the aforementioned configuration.

The radiation image capturing apparatus of the embodiments described above may be applied to a breast image capturing and display system for capturing a breast image, a radiation image capturing system that perform image capturing operation with a subject in the upright position, a radiation image capturing system that perform image capturing operation with a subject in the lateral position, a radiation image capturing, system capable of performing image capturing operation with a subject in the upright position or in the lateral position, a radiation image capturing system that performs long length imaging, and the like.

Further, the radiation image capturing apparatus of the embodiments described above may also be applied to a radiation phase contrast X-ray CT system for obtaining a three-dimensional image, a stereoscopic imaging system for obtaining a stereoscopically viewable image, a tomosynthesis imaging system for obtaining a tomographic image, and the like.

What is claimed is:

1. A radiation image capturing apparatus, comprising:
a first grid which includes grid structures disposed at intervals and forms a first periodic pattern image by passing radiation emitted from a radiation source;
a second grid which includes grid structures disposed at intervals and forms a second periodic pattern image by receiving the first periodic pattern image;
a radiation image detector in which pixel circuits for detecting the second periodic pattern image formed by the second grid are disposed two-dimensionally; and
an image generation unit that generates a phase contrast image based on an image signal representing the second periodic pattern image detected by the radiation image detector, wherein:
either one of the first and second grids is a grid in which a plurality of unit grids is arranged, each unit grid corresponding to each of the pixel circuits, and at least three unit grids in a predetermined area corresponding to one pixel of the phase contrast image are disposed shifted in parallel with respect to the other grid by different distances in a direction perpendicular to an extending direction of the other grid;
the radiation image detector includes a plurality of arithmetic units for calculating at least two signals for generating the one pixel of the phase contrast image based on pixel signals read out from pixel circuits corresponding to the at least three unit grids in the predetermined area, the number of the signals being smaller than the number of the pixel signals; and
the image generation unit is a unit that generates the phase contrast image based on the signals outputted from the plurality of arithmetic units of the radiation image detector.

2. The radiation image capturing apparatus of claim 1, wherein each of the unit grids is formed in a rectangular shape.

3. The radiation image capturing apparatus of claim 1, wherein images of the plurality of unit grids in the predetermined area are disposed shifted in parallel with respect to the other grid in increments of P/M, where P is a pitch of the other grid and M is a predetermined number of pieces of phase information used for generating an image signal of one pixel of the phase contrast image.

4. The radiation image capturing apparatus of claim 1, wherein pixel circuits corresponding to at least four unit grids in the predetermined area are disposed point symmetrically.

5. The radiation image capturing apparatus of claim 1, wherein each of the arithmetic units includes a differential operation circuit for calculating a differential signal between pixel signals read out from pixel circuits corresponding to at least two unit grids in the predetermined area.

6. The radiation image capturing apparatus of claim 5, wherein the image generation unit is a unit that generates a pixel signal of one pixel of the phase contrast image based on a ratio between two signals outputted from two differential operation circuits respectively.

7. The radiation image capturing apparatus of claim 1, wherein:
each of the pixel circuits includes a switching element and a pixel signal of each pixel circuit is read out by causing the switching element to be switched to ON; and
a scanning line to which a scanning signal for switching each of the switching elements to ON is provided at least every two rows of the pixel circuits.

8. The radiation image capturing apparatus of claim 1, wherein the second grid is a grid disposed at a Talbot interference distance from the first grid and intensity modulates the first periodic pattern image formed by the Talbot interference effect of the first grid.

9. The radiation image capturing apparatus of claim 1, wherein:
the first grid is an absorption grid that forms the first periodic pattern image by passing the radiation as a projection image; and
the second grid is a grid that intensity modulates the first periodic pattern image as the projection image passed through the first grid.

10. The radiation image capturing apparatus of claim 9, wherein the second grid is disposed at a distance shorter than a minimum Talbot interference distance from the first grid.

11. A radiation image detector in which pixel circuits for detecting an electric charge generated by receiving radiation are disposed two-dimensionally, wherein the detector comprises a plurality of arithmetic units for calculating at least two signals based on pixel signals read out from at least three pixel circuits in a predetermined area, the number the signals being smaller than the number of the pixel signals.

12. The radiation image detector of claim 11, wherein each of the arithmetic units comprises a differential operation circuit for calculating a differential signal between pixel signals read out from at least two pixel circuits in the predetermined area.

13. The radiation image detector of claim 11, wherein:
each of the pixel circuits includes a switching element and a pixel signal of each pixel circuit is read out by causing the switching element to be switched to ON; and
a scanning line to which a scanning signal for switching each of the switching elements to ON is provided at least every two rows of the pixel circuits.
